(19) United States
(12) Patent Application Publication
(10) Pub. No.: US 2021/0256236 A1
(43) Pub. Date: Aug. 19, 2021

(54) Fingerprint Detecting System and Related Method

(71) Applicant: NOVATEK Microelectronics Corp., Hsin-Chu (TW)

(72) Inventors: Hung-Kai Chen, Taipei City (TW); Ting-Hsuan Hung, Hsinchu City (TW); Chih-Yuan Chang, Hsinchu County (TW); Feng-Lin Chan, Hsinchu County (TW)

(21) Appl. No.: 16/790,636

(22) Filed: Feb. 13, 2020

(51) Int. Cl. G06K 9/00

(52) U.S. Cl. CPC G06K 9/0002; G06K 9/00067

(57) ABSTRACT

A fingerprint detecting system comprises a fingerprint module, for detecting a fingerprint of a user and outputting a current signal according to the detected fingerprint, and a signal processing circuit, coupled to the fingerprint module, for receiving the current signal from the fingerprint module, performing a offset cancellation for the current signal to remove an offset of the current signal, and converting the current signal without the offset to a voltage signal for fingerprint data analysis.

### BACKGROUND OF THE INVENTION

### 1. Field of the Invention

The present invention relates to a fingerprint detecting system, and more particularly, to a fingerprint detecting system with current sensing.

### 2. Description of the Prior Art

With advancements in technology, mobile devices such as smart phones, tablets, laptops, GPS navigation systems and electronic books have become indispensable in our daily life. Compared with mobile devices that only have communication functions, modern mobile devices combine various functions such as communication, networking, photographing, games and data processing. This type of multifunctional design is more attractive to consumers. Fingerprint recognition is a popular function for security and privacy. For example, a mobile phone may have a fingerprint module built into a home button or in a dedicated region (e.g. a sensor pad) to detect user fingerprint.

In recent years, the optical fingerprint detection has become one of the most popular fingerprint detection schemes. Please refer to FIG. 1, which is a schematic diagram of the structure of the fingerprint detecting system 10. The fingerprint detecting system 10 includes a fingerprint module and a readout integrated circuit ROIC. In addition, the fingerprint module includes a sensor pad configured to contact a finger of a user and sense the light reflected by the finger. For detailed fingerprint detecting operation, the fingerprint module receives a fingerprint driving signal “Write” to enable the detecting function of the fingerprint module, and then outputs voltages corresponding to the sensed lights reflected by the fingerprint, to the readout integrated circuit ROIC to determine the voltage difference between the finger valley and finger ridge. That is, the readout integrated circuit ROIC determines the finger valley and finger ridge of the fingerprint according to the voltage differences between the finger valley and finger ridge, to obtain the fingerprint data for analysis.

However, the readout integrated circuit ROIC requires high resolution for determining the voltage difference between the finger valley and finger ridge since the voltage variation is quite small. Besides, the sensor pad of the fingerprint module requires long exposure time to accumulate the output voltages, which results in that the readout integrated circuit ROIC requires wide voltage dynamic range for sensing the voltage from the sensor pad since the sensed light on the sensor pad may be different over time (e.g. high lumen or low lumen significantly affects the output voltage range of the sensor pad). Thus, it is difficult to design a readout integrated circuit ROIC with these requirements.

### SUMMARY OF THE INVENTION

It is therefore an objective to provide a fingerprint detecting system to solve the above problem.

An embodiment of the present invention discloses a fingerprint detecting system. The fingerprint detecting system comprises a fingerprint module, for detecting a fingerprint of a user and outputting a current signal according to the detected fingerprint, and a signal processing circuit, coupled to the fingerprint module, for receiving the current signal from the fingerprint module, performing a offset cancellation for the current signal to remove an offset of the current signal, and converting the current signal without the offset to a voltage signal for fingerprint data analysis.

Another embodiment of the present invention discloses a method of fingerprint detection for a signal processing circuit of a fingerprint detecting system. The method comprises receiving a current signal from a fingerprint module of the fingerprint detecting system, performing a offset cancellation for the current signal, to generate a compensation signal, generating a current difference signal according to the compensation signal and the current signal, converting the current difference signal to a voltage signal, and converting the voltage signal from an analog signal to a digital signal for a fingerprint data analysis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a fingerprint detecting system according to the prior art.

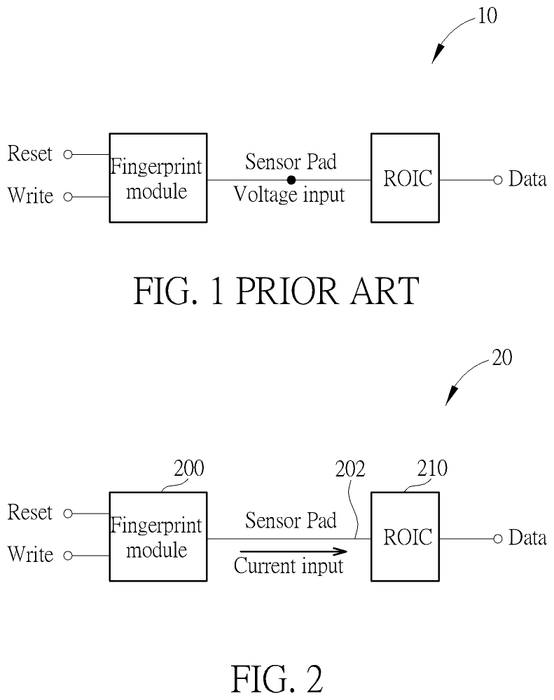

FIGS. 2-3 are schematic diagrams of a fingerprint detecting system according to an embodiment.

FIG. 4 is a schematic diagram of an operation of a fingerprint detecting system according to an embodiment.

### DETAILED DESCRIPTION

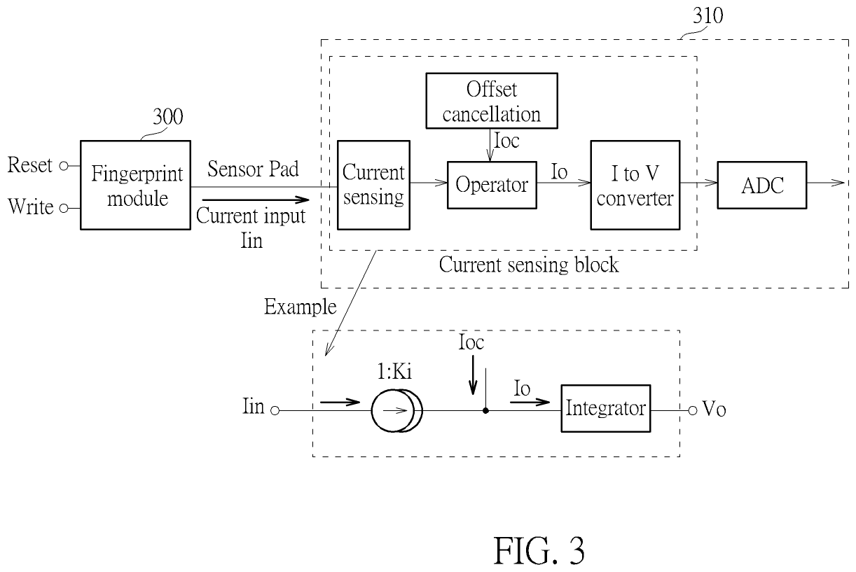

Please refer to FIG. 2, which is a schematic diagram of a fingerprint detecting system 20. The fingerprint detecting system 20 includes a fingerprint module 200 and a signal processing circuit 210 coupled to the fingerprint module 200. The fingerprint module 200 receives fingerprint driving signal “Write” (e.g. a DC voltage signal) for enabling the fingerprint detection function. The fingerprint module 200 includes a sensor pad 202 to detect light reflected from the fingerprint of the user, and therefore generates the current signal according to the detected signal. In an embodiment, the sensor pad 202 of the fingerprint module 200 is provided a fixed voltage, so that the sensor pad 202 outputs the current signal according to the detected signal. On the other hand, the signal processing circuit 210 receives the current signal from the sensor pad 202 of the fingerprint module 200, and performs fingerprint data analysis based on the current signal. In detail, after the signal processing circuit 210 receives the current signal, the signal processing circuit 210 performs offset cancellation to remove the current offset from the current signal. In addition, the signal processing circuit 210 calculates a current difference according to the current signal and the offset removed current signal, to generate the current difference signal. Finally, the signal processing circuit 210 converts the current difference signal to a voltage signal, and then outputs to an analog to digital converter, ADC, of the signal processing circuit 210, to convert the voltage signal from an analog signal to a digital signal for fingerprint data analysis. Note that, in an embodiment, the current difference signal is not converted to the voltage signal, but directly outputted to a current-based ADC for fingerprint data analysis.

In a word, the fingerprint module 200 outputs the current signal as a fingerprint signal to the signal processing circuit 210, such that the voltage dynamic range of the signal processing circuit 210 could be reduced. In addition, the signal processing circuit 210 applies offset cancellation to compensation system offset, where the current offset may be caused by DC current under strong light, device leakage and pad differences. With current compensation, the current dynamic range could be reduced, to simplify the input dynamic range for the ADC.

The present invention aims at providing the signal processing method for the fingerprint detecting system 20. Those skilled in the art may make modifications and alternations accordingly. Reference is made to FIG. 3. In FIG. 3, the sensor pad of the fingerprint module 300 generates the current signal Iᵢₙ according to the detected signal (e.g. the light reflected by the fingerprint of the user). In an embodiment, the signal processing circuit 310 includes current sensing block, which includes the current sensing unit, the calculation unit, the offset cancellation unit, the current-to-voltage converter. In detail, the current sensing unit is used for measuring the current signal Iᵢₙ outputted from the fingerprint module 300, the offset cancellation unit is used for generating an compensation signal I_{oc} according to the current signal Iᵢₙ, the calculation unit (e.g. an operator) is used for generating the current difference signal I_{oc} according to the current signal Iᵢₙ and the compensation signal I_{oc}, and the current-to-voltage converter is used for converting the current difference signal Iₒ to the voltage signal Vₒ. Therefore, the ADC of the signal processing circuit 310 converts the voltage signal Vₒ from an analog signal to a digital signal for fingerprint data analysis. In an embodiment, the current-to-voltage converter is an integrator for converting a current signal to a voltage signal. That is, the current difference signal is amplified by the current-to-voltage converter, to convert the current signal to a voltage signal.

In a word, the signal processing circuit 310 performs offset cancellation to compensate the current offset caused by the fingerprint module. In an embodiment, the offset cancellation unit could output a signal in a form of current/voltage/charge, which is not limited herein. In this case, only current difference part (via the operator) is converted to the voltage signal and then sent to the ADC for fingerprint data analysis. Thus, the ADC could be easily designed to fulfill the requirements due to voltage dynamic range of the ADC/signal processing circuit 310 is simplified with the current difference, whereas the convention ADC is designed to process with voltage difference, which requires wide voltage dynamic range.

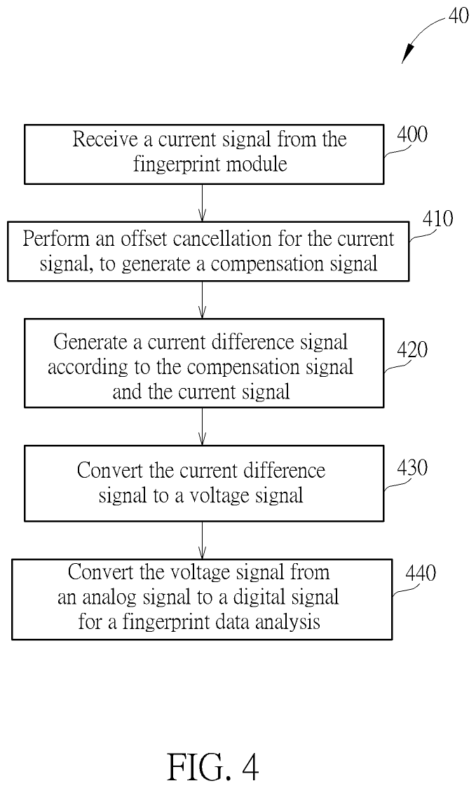

The abovementioned operation for the fingerprint detecting system may be summarized into a signal processing process 40, as shown in FIG. 4. The signal processing process 40, which may be implemented in the fingerprint detecting system of FIGS. 2-3, includes the following steps:

Step 400: Receive a current signal from the fingerprint module.

Step 410: Perform an offset cancellation for the current signal, to generate a compensation signal.

Step 420: Generate a current difference signal according to the compensation signal and the current signal.

Step 430: Convert the current difference signal to a voltage signal.

Step 440: Convert the voltage signal from an analog signal to a digital signal for a fingerprint data analysis.

According to the signal processing process 40, the current signal is inputted to the signal processing circuit, and thus the ADC performs fingerprint data analysis with the voltage signal converted by the current signal, to reduce the voltage dynamic range of the ADC/signal processing circuit. The detailed operations of the fingerprint detecting system are illustrated in the above paragraphs, so it is omitted herein. Note that,

In conclusion, the present invention addresses to increase fingerprint recognition accuracy for the fingerprint detecting system, to increase the reliability of the fingerprint recognition. In detail, the fingerprint module outputs current signal as the fingerprint signal to the signal processing circuit. The signal processing circuit performs offset cancellation, to obtain the current difference, and then converts the current difference to the voltage difference for fingerprint data analysis, so that the voltage dynamic range of the ADC/signal processing circuit could be reduced. Thus, the ADC or the signal processing circuit design of the fingerprint detecting system is simplified to fulfill the requirements.

Those skilled in the art will readily observe that numerous modifications and alterations of the device and method may be made while retaining the teachings of the invention. Accordingly, the above disclosure should be construed as limited only by the metes and bounds of the appended claims.

1. A fingerprint detecting system comprising:
a fingerprint sensing circuit, configured to detect a light reflected from a fingerprint of a user and output a current signal as a fingerprint signal according to the detected fingerprint; and
a signal processing circuit, coupled to the fingerprint sensing circuit, for receiving the current signal from the fingerprint sensing circuit, performing an offset cancellation for the current signal to remove an offset of the current signal, and converting the current signal without the offset to a voltage signal for fingerprint data analysis.

2. The fingerprint detecting system of claim 1, wherein the signal processing circuit measures the current signal outputted from the fingerprint sensing circuit, removes the offset of the current signal, to generate a compensation signal, generates a current difference signal according to the current signal and the compensation signal, and converts the current difference signal to a voltage signal.

3. The fingerprint detecting system of claim 2, wherein the signal processing circuit comprises an integrator performed on the current difference signal.

4. The fingerprint detecting system of claim 2, wherein the signal processing circuit comprises an operator performed on the current signal and the compensation signal, to generate the current difference signal.

5. The fingerprint detecting system of claim 1, wherein the fingerprint sensing circuit is provided a constant voltage to output the current signal.

6. A method of fingerprint detection for a signal processing circuit of a fingerprint detecting system, the method comprising:
receiving a current signal from a fingerprint sensing circuit of the fingerprint detecting system;
performing an offset cancellation for the current signal, to generate a compensation signal;
generating a current difference signal according to the compensation signal and the current signal;
converting the current difference signal to a voltage signal; and
converting the voltage signal from an analog signal to a digital signal for a fingerprint data analysis;
wherein the fingerprint sensing circuit detects a light reflected from a fingerprint of a user and outputs the current signal as a fingerprint signal according to the detected fingerprint.
